(19) United States
(12) Patent Application Publication
(10) Pub. No.: US 2004/0060370 A1
(43) Pub. Date: Apr. 1, 2004

(54) Method for determining the pole-wheel position of electric machinery

(76) Inventors: Gerhard Koelle, Wirnsheim (DE); Beqir Pushkolli, Ludwigsburg (DE)

Correspondence Address: Striker Striker & Stenby, 103 East Neck Road, Huntington, NY, 11743, US

(21) Appl. No.: 10/030,469

(22) PCT Filed: Mar. 23, 2001
(86) PCT No.: PCT/DE01/01122

(30) Foreign Application Priority Data
May 16, 2000 (DE) 100 23 908.0

(51) Int. Cl. G01L 3/02

(52) U.S. Cl. 73/862.325

(57) ABSTRACT

The invention relates to a method for ascertaining the pole wheel position in electrical machines (1), for example rotary current generators with pulse inverters. These electrical machines have a rotor excitation device (2) and a stator (4) provided with inductances (4.1, 4.2, 4.3 or 20, 21, 22). An alternating voltage source (7) is provided on the stator output side, between two stationary terminals (5). By means of first and second switch elements (15, 16), a split into two branches (13 and 14) can be produced, in which the respective branch voltage curves (17, 18) are measured, the superposition of which permits the rotor or pole wheel position (11) to be definitely ascertained.

### TECHNICAL FIELD

Electrical power in motor vehicles today is usually generated by means, of claw-pole generators. These electrical machines in the form of rotary current machines, are connected to the on-board electrical system of the vehicle via a diode-rectifier bridge. The on-board electrical system of a modern motor vehicle is usually a direct current system. The generators are dimensioned so that they can produce the required electrical power even when an internal combustion engine is idling.

### PRIOR ART

Since motor vehicles are being equipped with an ever increasing number of electrical consumers such as electrical seat adjusters and seat back adjusters, electrical actuators for vertically extending glass roofs or sliding glass sunroofs, as well as power-window units and the like, demand for the production of sufficient electrical power is constantly on the rise. In order to be able to reliably fulfill the expected increase in power demand in the future, much consideration is being given to equipping the generators, which are embodied as claw-pole generators, with a pulse inverter in order to produce the required power even at low speeds such as the engine idling speed.

Particularly during the starting phase, it is required that the electrical machine of the rotary current generator with a pulse inverter already exert the maximal possible torque on its shaft during this starting phase. However, this is only possible if the starting position of the rotor is known. As a rule, a pole wheel transmitter is used in the claw-pole generators in use today. In addition to the use of a pole wheel transmitter, the starting position of the pole wheel can also be determined by means of an observation device. In both cases, both when an observation device is used and when a pole wheel transmitter is used, information regarding the starting value of the pole wheel transmitter is essential.

### DEPICTION OF THE INVENTION

With the method proposed according to the invention, it is possible to use a branch point to plot two occurring alternating voltage curves. At the branch point of the measurement circuit, there can be a split into two voltage branches, each of which contains an alternating voltage source. The alternating voltage source produces voltage curves that vary over time, for example sinusoidal voltage curves, in the respective voltage branches of the electrical machine.

By measuring the voltage curve in a first position of a switch element and measuring the voltage curve in a second position of a switch element, the exact position of the rotor and therefore of the pole wheel can be determined since it is known which respective branch the measurement is being carried out in. Superimposing the voltage curves occurring in the respective voltage branches prevents a voltage value u_{C} from being occupied by two rotor positions, which has been the unsatisfactory situation up till now.

It is irrelevant whether the stator in the electrical machine is wired in the form of a star-shaped circuit or a triangular circuit. The individual voltage curves occurring in the branches can be stored in tabular form and can be used again for similar electrical machines. The use of a pole wheel transmitter and the costs associated with it can therefore be avoided. Despite the lack of the pole wheel transmitter, the method proposed according to the invention permits the position of the rotor to be ascertained so precisely that at the start of the rotary current generator, the maximal possible torque is applied to its shaft.

### DRAWINGS

The invention will be explained in detail below in conjunction with the drawings.

FIG. 1 shows the circuit embodied as a star-shaped circuit with an alternating voltage source,

FIG. 2 shows the many-valued voltage curve u_{C} that occurs, plotted over the rotor position, expressed in angular degrees,

FIG. 3 shows a star-shaped circuit with branch points in their voltage branches, which each contain an alternating voltage source,

FIG. 4 shows the voltage courses u_{C} and u_{R} plotted over the rotor position in angular degrees, and

FIG. 5 shows the rotary current generator wired according to FIG. 3, with a stator embodied in the form of a triangular circuit.

### VARIOUS EMBODIMENTS

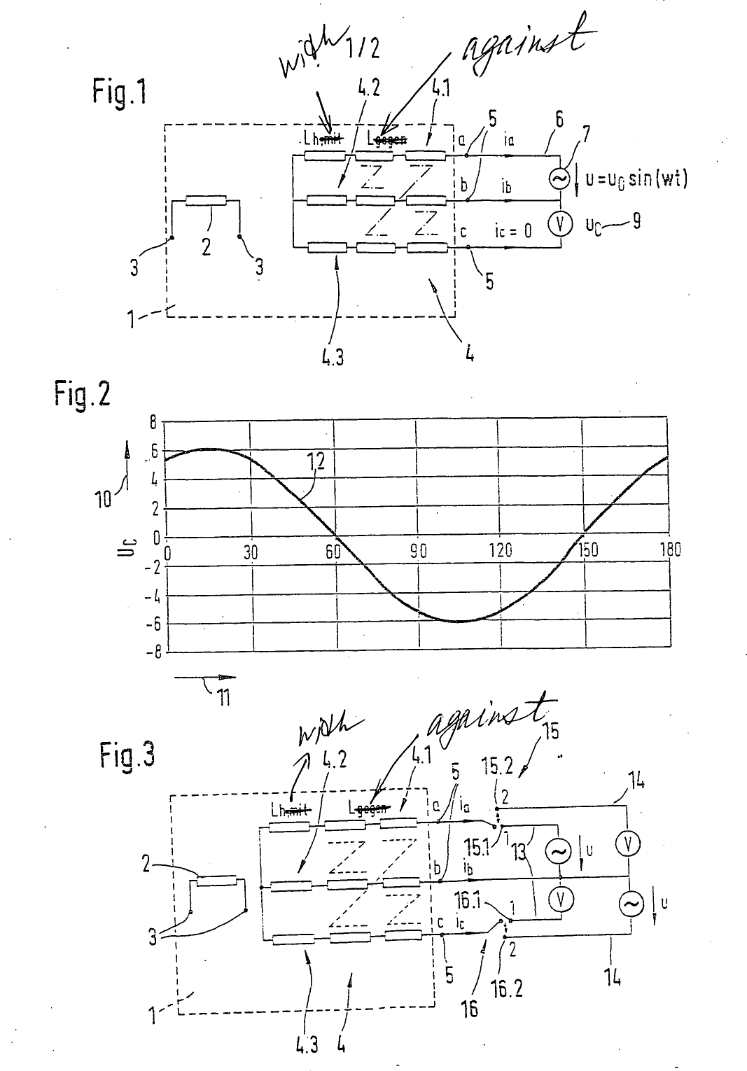

FIG. 1 shows the wiring of an electrical machine, for example a rotary current generator embodied in the form of a star-shaped circuit with an alternating voltage source.

A rotary current generator 1, depicted only schematically according to FIG. 1 with a rotor excitation device 2 and stator induction windings 4.1, 4.2, and 4.3, is provided with a measurement circuit at its terminals 5. The terminals 5 of the voltage branches a, b, and c are current-carrying except for branch c. An alternating voltage source is contained between the terminals a, b, which produces a voltage curve that changes over time, for example a sinusoidal voltage curve u=u₀ sin (ωt).

The terminals that connect the individual voltage branches of the measurement circuit to the respective output terminals 5 of the rotary current generator 1 are labeled a, b, and c.

FIG. 2 shows the many-valued voltage curve u_{C} that occurs, plotted over the rotor position, expressed in angular degrees.

The graph according to FIG. 2 shows a half rotor rotation 11, from 0° of rotation angle to 180° of rotation angle. The voltage curve u_{C} that occurs, identified with the reference numeral 9, describes a sinusoidal oscillation. For a particular value of for example 2V, two rotor positions 11 can be identified, namely approx. 50° and 160° of rotation angle of the rotor, as a result of which the pole wheel position is not definite.

From this pair of values, which have been selected by way of an example, it can be deduced that two rotor positions can be inferred from a discrete voltage u_{C}, which does not permit a definite association of the actual rotor wheel position with the measured voltage.

However, in FIG. 3, a rotary current machine is provided with a star-shaped circuit on the stator side, as well as with two individual switching circuits subordinate to the stator.

FIG. 3 shows that the rotary current generator 1 contains a rotor excitation device 2, which has two connecting terminals. The individual stator winding packets of the stator 4 of the rotary current generator 1 are labeled with the reference numerals 4.1, 4.2, and 4.3. On the output side of the rotary current machine, terminals 5 are provided, which are analogous to the ones shown in FIG. 1 and are labeled with the letters a, b, and c.

According to the proposed invention, switch elements 15 and 16 are integrated into the voltage branches leading from the individual terminals 5. In the switching state shown in FIG. 3, in position 15.1 and 16.1, the switch elements 15 and 16 contact the connection terminals of an internally disposed voltage branch 13 that contains an alternating voltage source (comparable to the alternating voltage source 7 according to FIG. 1). In the state shown in FIG. 3, which corresponds to the switch position 15.1, the measuring voltage in the voltage branch 13 is measured.

In addition to their first switch position 15.1 and 16.1, the switch elements 15 and 16 also assume a second switch position, identified by the reference numerals 15.2 and 16.2. In this second switch position, the switch elements contact the connection terminals of an outer voltage branch 14, which analogous to the inner voltage branch 13, likewise contains an alternating voltage source. If the chronological course of a voltage U_{R} (voltage curve 18) is measured in the inner voltage branch 13, then the switch elements 15 and 16, are disposed in their first switch positions, labeled with the reference numerals 15.1 and 16.1 so that the stator windings 4.1, 4.2, 4.3 are connected to the measurement circuit via the terminals 5a, c.

In this state, the connections 15.2 and 16.2 of the outer voltage branch 14 are without current.

If the first switch 15 and the second switch 16 are disposed in the second switch positions labeled 15.2 and 16.2, then the inner voltage branch 13 is not connected to the output terminals 5a) and 5c) of the stator of the rotary current generator, but instead the outer voltage branch 14 is connected to them. As a result, a measurement can take place that measures the decreasing voltage u_{C} at the alternating voltage source, which voltage is also labeled with the reference numeral 17. From the voltage curves 17 and 18 or u_{R} and u_{C} that can be determined with the measurement circuit shown in FIG. 3, the voltage curves in the two branches can be measured in definite states.

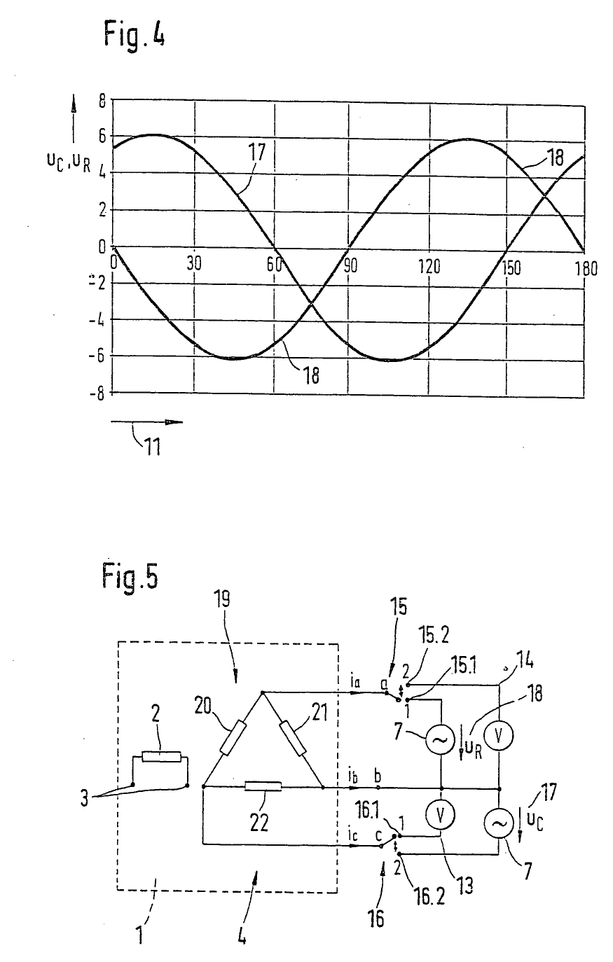

FIG. 4 shows the voltage curves occurring in the outer voltage branch 14 and in the inner voltage branch 13.

In FIG. 4, the voltage drop occurring is plotted over the rotor position 11. It can be inferred from the graph that with regard to the rotor position 11, the voltage curve 18 u_{R} lags the voltage curve u_{C} labeled with the reference numeral 17 by 60°. In order for the recording of the measurement voltages with the measurement circuit according to FIG. 3 to be precisely defined with regard to which voltage curve 17 or 18 is picked up in which of the voltage branches 13 and 14, a rotor position 11 can be precisely associated with one of the respective voltage curves u_{C} and u_{R} based on the superimposed representation of the two voltage curves. A tabular association of the respective voltage values for the voltage drops u_{C} or u_{R} in tabular form permits each position of the rotor or pole wheel of an electrical machine embodied as a rotary current generator to be directly associated with a respectively determined voltage value. As a result, an electrical machine such as a rotary current generator 1 does not have to be equipped with a pole wheel position transmitter. Based on the tabular association of each rotor position 11 with regard to the voltage curves u_{C}, reference numeral 17 or u_{R}, reference numeral 18, measured in the voltage branches 13 and 14, the respective voltage curves u_{C} and u_{R} and the corresponding rotor position can also be determined for other electrical machines as well. As a result, a tabular association between the voltage curves and the angular position of the rotor or pole wheel can be generated, which permits conclusions to be drawn regarding the pole wheel position and therefore regarding the electrical power available in the on-board electrical system of a motor vehicle during the starting phase of the electrical machine. The information obtained by means of the measurement circuit shown in FIG. 3 regarding the association of the pole wheel position to voltage curves consequently also permits a simplification in similarly configured electrical machines so that theoretically, one series of measurements taken is sufficient to render the pole wheel transmitter superfluous and thereby lower costs in all electrical machines such as rotary current generators 1 that are designed in accordance with the claw-pole principle.

FIG. 5 shows a rotary current generator with the measurement circuit according to FIG. 3, where the stator of this electrical machine 1 is wired in the form of a triangular circuit.

The electrical machine, for example a rotary current generator, which is only shown in a schematic form, has a rotor excitation device 2 whose excitation current is supplied to the terminals 3. The stator 4 of the electrical machine according to FIG. 5 is embodied in the form of a triangular circuit, where the stator 4 includes three windings 20, 21, and 22. Analogous to the embodiment shown in FIG. 3, the voltages are measured in the three conductors coming out of the rotary current generator 1. Analogous to the measurement circuit configured in FIG. 3, an external voltage branch 14 and an internal voltage branch 13 are shown in the circuit according to FIG. 5. The inner voltage branch 13 contains an alternating voltage source 7, which applies a voltage curve that changes over time, for example in the form of a sinusoidal voltage. The ends of the inner voltage branch 13 are respectively equipped with the terminals 15.1 and 16.1, which simultaneously define a first switch position of the switches 15 and 16 provided previously. In an analogous embodiment of the outer voltage branch 14, it likewise contains a voltage source 7, which produces a voltage that changes over time and at its ends, is likewise provided with terminals 15.2 and 16.2 that define second switch positions. The switch elements that are contained in the terminal branches a and c of the rotary current generator 1 can be connected to the inner voltage branch 13 by a first switch position 15.1 and 16.1, while the connection of the switch element 15 or 16 to the in the second switch positions 15.2 and 16.2 represents the connection to the outer voltage branch 14. The voltage curves occurring in the inner voltage branch 13 and the outer voltage branch 14 with this measurement circuit can be analogously inferred from the depiction according to FIG. 4, by the voltage curves 17 and 18, u_{C}, u_{R} being plotted over the rotor position 11.

Typical values for an electrical machine embodied in the form of a rotary current generator, which is dimensioned according to the current invention, are the armature current iₐ of 50 A×sin(ωt), where ω=10,000 s⁻¹. The associated field current if is 0 amperes, where the series inductance I_{d} is 70 μH. The determination of the rotor position is independent of the magnitude of the excitation current in the excitation circuit and can therefore even take place when the excitation coil is not supplied with power. It is also irrelevant whether the stator winding 4 of the electrical machine 1 is provided in the form of a star-shaped circuit, with inductances 4.1, 4.2, and 4.3 wired in a star shape according to FIG. 3, or the stator circuit is provided in the form of a triangular circuit, with windings 20, 21, 22 wired in a triangular shape.

### Reference Numeral List

1 rotary current generator

2 rotary excitation device

3 terminals

4 stator

4.1 winding packet

4.2 winding packet

4.3 winding packet

5 terminal

6 armature current

7 alternating voltage source

8 field current

9 voltage drop capacitor

10 voltage curve u_{C}

11 rotor position

12 voltage curve 0° to 180°

13 voltage branch

14 voltage branch

15 first switch

15.1 switch position 1

15.2 switch position 2

16 second switch

16.1 switch position 1

16.2 switch position 2

17 voltage curve u_{C}

18 voltage curve u_{R}

19 stator triangular circuit

20 winding segment

21 winding segment

22 winding segment

23 generator terminals

1. A method for ascertaining the pole wheel position in electrical machines (1), for example rotary current generators, with pulse inverters, a rotor excitation device (2), a stator (4) provided with inductances (4.1, 4.2, 4.3); (20, 21, 22), and a voltage source (7) between two branch terminals (5), characterized in that by means of switch elements (15, 16), a split into two branches (13, 14) can be produced, in which the respective branch voltage curves (17 and 18) are measured, the superposition of which permits the pole wheel position (11) to be definitely ascertained.

2. The method according to claim 1, characterized in that the voltage source (7) is an alternating voltage source with a voltage curve (12; 17, 18) that changes over time.

3. The method according to claim 1, characterized in that the voltage source (7) is an alternating voltage source with a sinusoidal voltage curve (12; 17, 18).

4. The method according to claim 1, characterized in that the windings (4.1, 4.2, 4.3) of the stator (4) are wired in a star-shaped circuit.

5. The method according to claim 1, characterized in that the windings (20, 21, 22) of the stator (4) are wired in a triangular circuit.

6. The method according to claim 1, characterized in that the in the first switch position (15.1 and 16.1), the voltage curve (18) u_{R} is measured in an inner branch (13).

7. The method according to claim 1, characterized in that in the second switch position (15.2 and 16.2), the voltage curve (17) u_{C} is measured in the outer branch (13).

8. The method according to claims 6 or 7, characterized in that the rotor position (11) for each of the voltage curves (17, 18) is stored in tabular form and can be transferred to similar electrical machines (1).

9. The method according to one or more of the preceding claims, characterized in that during the starting phase of the rotary current generator (1), the rotor or pole wheel position corresponds to the rotor or pole wheel position in which it is possible to exert the maximal possible torque to the drive shaft of the electrical machine (1).
